(19) United States
(12) Patent Application Publication
(10) Pub. No.: US 2026/0257517 A1
(43) Pub. Date: Sep. 3, 2026

(54) TIRE WITH RECYCLED RUBBER IN CROWN

(71) Applicants: Tyler SITES, Greenville, SC (US); Candy TSIAO, Greenville, SC (US); Alexandra SNYDER, Greenville, SC (US); COMPAGNIE GENERALE DES ETABLISSEMENT MICHELIN, Clermont-Ferrand (FR)

(72) Inventors: Tyler SITES, Greenville, SC (US); Candy TSIAO, Simpsonville, SC (US); Alexandra SNYDER, Harrisburg, PA (US)

(21) Appl. No.: 19/489,461

(22) PCT Filed: Jun. 17, 2024
(86) PCT No.: PCT/US2024/034327

§ 371 Date: Dec. 2, 2025

Related U.S. Application Data
(60) Provisional application No. 63/509,561, filed on Jun. 22, 2023.

(51) Int. Cl. B60C 11/00; B60C 1/00; B60C 9/18; B60C 9/20

(52) U.S. Cl. CPC B60C 11/0008; B60C 1/0016; B60C 9/185; B60C 9/2006; B60C 11/0075; B60C 2001/0075; B60C 2009/1878

(57) ABSTRACT

A tire is provided that has crown with an undertread layer that has a recycled portion that includes recycled rubber, and a virgin portion that includes virgin rubber. A cushion layer of the crown has a recycled section that includes recycled rubber and a virgin section that includes virgin rubber. A plurality of belt layers are located between the undertread layer and the cushion layer in the radial direction. The virgin portion engages a first one of the plurality of belts and is located proximate to a first axial end of the first one of the plurality of belts. The virgin section engages a second one of the plurality of belts and is located proximate to a second axial end of the second one of the plurality of belts.

### STATEMENT REGARDING FEDERALLY SPONSORED RESEARCH OR DEVELOPMENT

This invention was made with government support under the Advanced Manufacturing Office Award Number DE-EE0007897 awarded by the U.S. Department of Energy's Office of Energy Efficiency and Renewable Energy (EERE). The Government has certain rights in the invention.

### FIELD OF THE INVENTION

The subject matter of the present invention relates to a tire that includes recycled rubber. More particularly, the present application involves a crown design that features both virgin bead filler and recycled bead filler strategically placed to maintain tire performance.

### BACKGROUND OF THE INVENTION

Once tires have gone through their useful life, they are removed from service and enter their after service life. Around 50% of tires upon entering their after service life are burned to create tire-derived fuel. Of the remaining after service life tires, some are repurposed into crumb rubber products, others are used for civil engineering applications, and the remaining after service life tires are ground and placed into landfills. In order to reduce the environmental impact of after service life tires, it may be desirable to repurpose rubber from after service tires into new tires that are being manufactured. However, only smaller amounts of recycled rubber are used in new tires because adding larger amounts of recycled rubber into new tires has been shown to lower functional properties such as strain modulus and tensile strength. It is therefore the case that using recycled rubber instead of new, virgin rubber in newly manufactured tires can degrade the tire's performance. This downside thus limits the applicability of recycled rubber into newly manufactured tires. It would therefore be desirable to design a tire that allows for the incorporation of recycled rubber into a newly manufactured tire without degrading the performance of the newly manufactured tire due to the incorporation of this recycled rubber.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of a heavy truck tire.

FIG. 2 is a cross-sectional view of a radial cut of a truck tire with all items in cross-section as the tire would look when mounted to a rim in accordance with one exemplary embodiment.

FIG. 3 is a cross-sectional view of a bead, sidewall and some of the crown portion of the FIG. 2 embodiment to show in close-up.

FIG. 4 is a cross-sectional view of a bead, sidewall, and some of the crown in accordance with another exemplary embodiment.

FIG. 5 is a cross-sectional view of a bead, sidewall, and some of the crown in accordance with yet another exemplary embodiment.

The use of identical or similar reference numerals in different figures denotes identical or similar features.

### DETAILED DESCRIPTION OF THE INVENTION

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

The present invention provides for a tire 10 with recycled rubber incorporated into the crown 26 in such a manner that endurance and durability is not compromised. In this regard, the crown 26 has an undertread layer 84 that has both a recycled portion 86 and a virgin portion 88. The recycled portion 86 has recycled rubber in it, and the virgin portion 88 includes virgin rubber and no recycled rubber. Also located within the crown 26 is a cushion layer 92 that likewise has both a recycled section 94 and a virgin section 96. The recycled section 94 includes recycled rubber, and the virgin section 96 includes virgin rubber with no recycled rubber therein. This arrangement of the undertread layer 84 and the cushion layer 92 allows for recycled rubber to be put into a newly manufactured tire 10 without degrading the performance of the tire 10.

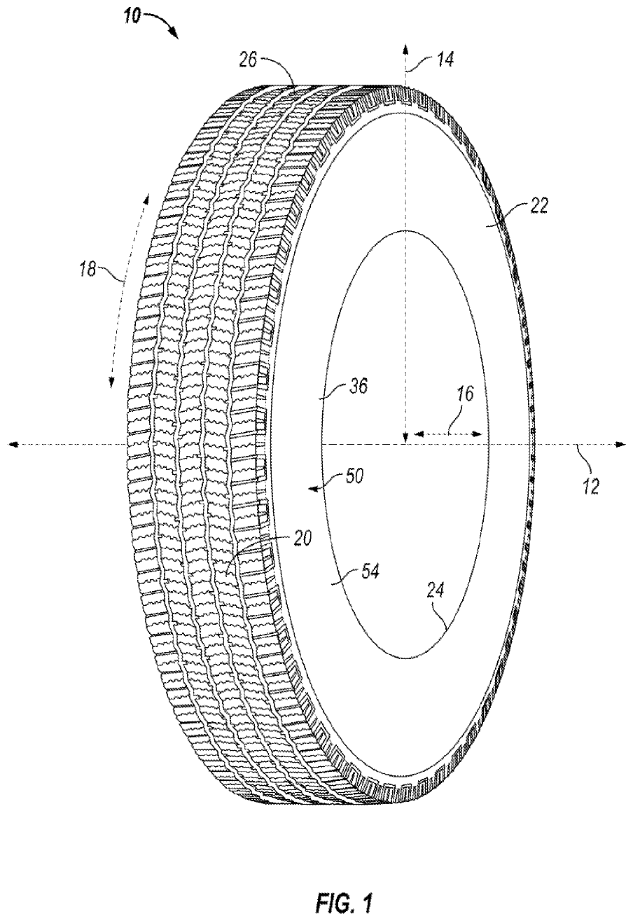

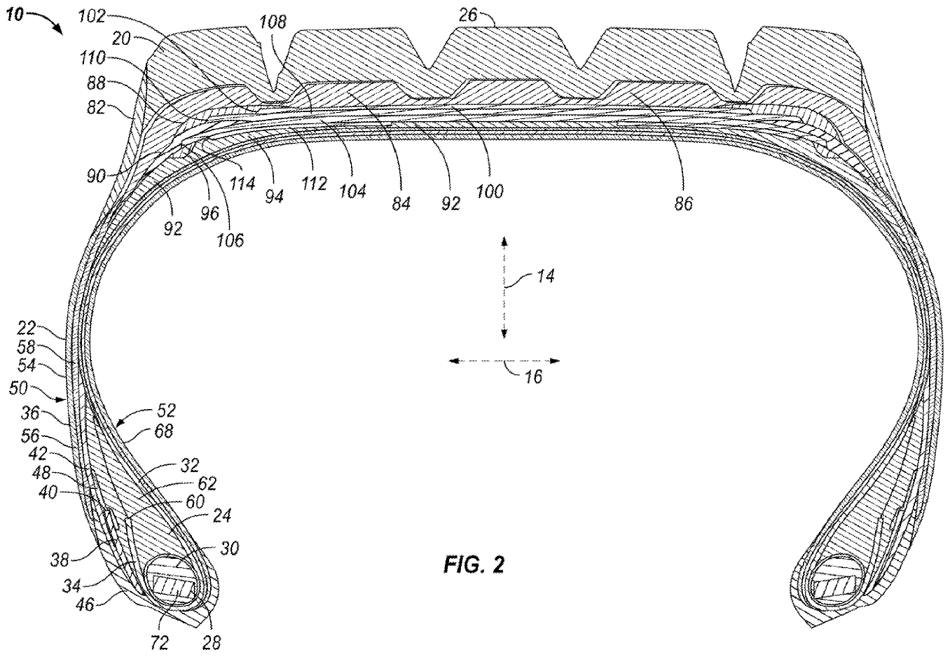

FIG. 1 shows a tire 10 that is a heavy duty truck tire 10. The tire 10 may be a steer tire, a drive tire, a trailer tire, or an all position tire. The tire 10 includes a casing 22 onto which a tread 20 is disposed thereon. The casing 22 may include the sidewall 36, beads 24, and a portion of the crown 26. The bead 24 is a part of the casing 22 that is at the inner radial end of the casing 22 closest to the central axis 12. The central axis 12 of the tire 10 extends through the center of the casing 22, and the axial direction 16 of the tire 10 is parallel to the central axis 12. The radial direction 14 of the tire 10 is perpendicular to the central axis 12, and the tread 20 is located farther from the central axis 12 in the radial direction 14 than the casing 22. The tread 20 extends all the way around the casing 22 in the circumferential direction 18 of the tire 10 and circles the central axis 12 360 degrees. Although described as being in use with heavy duty truck tires 10, the tire 10 as provided in accordance with the present invention may be any type of tire 10 such as a light duty vehicle tire, a light truck tire, a passenger car tire, or any other type of tire 10. However, certain embodiments exist in which the tire 10 is a heavy duty truck tire 10. As used herein, the directions described as being outward or inward in the radial direction 14 mean farther or closer to something relative to the central axis 12 in the radial direction 14. The directions described as being inboard or outboard in the axial direction 16 mean closer to or farther from the center line of the tire 10 in the axial direction 16 that is designated as the radial direction 14 line in FIG. 2.

FIG. 2 is a radial cut of a tire 10 in accordance with one exemplary embodiment. Various tissues, sometimes called products, composed of different materials can be present throughout the tire 10. The tread 20 of the tire 10 is shown as being located farthest from the axial center of the tire 10 in the radial direction 14. The crown 26 of the tire 10 is the portion of the tire 10 that engages the road surface, and in particular the tread 20 is designed for engaging the ground. The crown 26 is at the center of the tire 10 in the axial direction 16, and a pair of sidewalls 36 extend from the crown 26 in the radial direction 14. Beads 24 are located at the ends of the sidewalls 36 in the radial direction 14 and are closest to the central axis 12 in the radial direction 14. The crown 26 includes a plurality of belt layers which are located below the tread 20 in the radial direction 14 and comprise belts for use in strengthening and holding the form of the tire 10. The reinforcement belts of the belt layers may be crossed relative to one another, and in some instances they can be arranged at an angle of 20 degrees to one another. Although four belt layers 100, 104, 108, 112 are present any number of belt layers may be present in other embodiments. The belt layers may include reinforcement belts made of steel. The casing 22, or carcass, extends from the tread 20 and includes sidewalls 36 of the tire 10 terminating in a pair of beads 24 that are arranged for mounting onto the rim of the wheel of the vehicle.

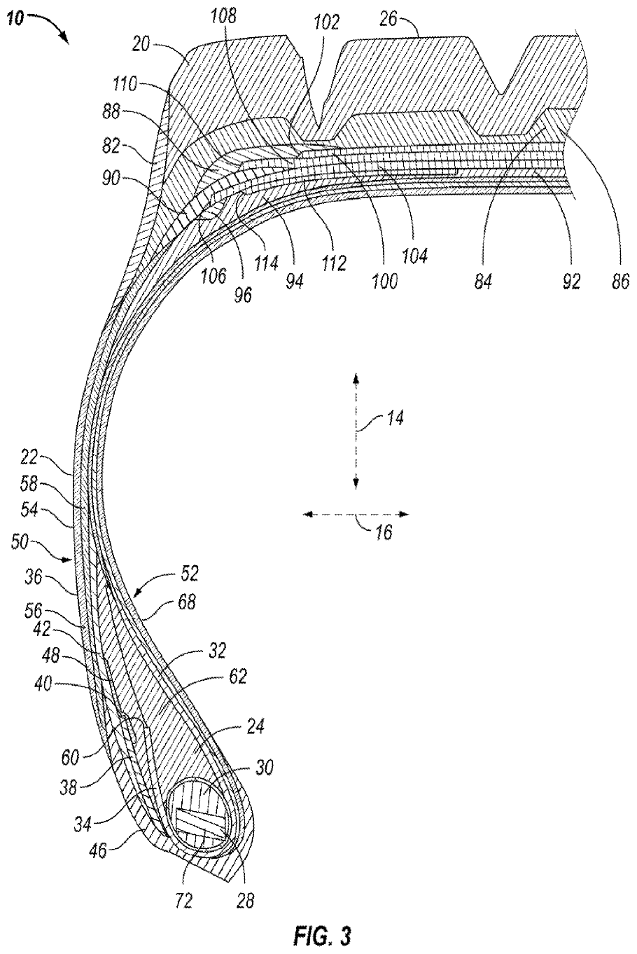

FIG. 3 shows the left side of the tire 10 of FIG. 2 so that the various tissues can be seen with greater detail. The tread 20 is in the crown 26 and provides the tire 10 with endurance by means of its compounds and design. The tread 20 engages the ground and provides the tire 10 with traction, abrasion resistance, and rolling resistance. The crown 26 includes an undertread layer 84 that is located below the tread 20 in the radial direction 14 and is in engagement with both the tread 20 and the belt layers. The undertread layer 84 extends along the entire crown 26 in the axial direction 16, and is made of a different type of rubber than that making up the tread 20. The undertread layer 84 may be made of materials that minimize heat generation from the tread 20 and steel belts in the belt layers. The undertread layer 84 can also function as an oil migration barrier, provide desirable tack, and have low hysteresis. However, these properties can be eliminated or modified in various tires 10 as desired.

The undertread layer 84 has a recycled portion 86 made with recycled rubber, and a virgin portion 88 made with virgin rubber. The recycled portion 86 has a larger volume, and a greater cross-sectional area, than does the virgin portion 88. The recycled portion 86 is a single continuous piece within the tire 10, but the virgin portion 88 is made of two different pieces in which one is on the left hand side of the tire 10 and the other is on the right hand side of the tire 10. The recycled portion 86 is located at the center of the tire 10 in the axial direction 16 and extends farther outboard in the axial direction 16 than does the virgin portion 88. The virgin portion 88 is not located at the center of the tire 10 in the axial direction 16. The recycled portion 86 engages the tread 20 and the virgin portion 88 does not engage the tread 20. Both the recycled portion 86 and the virgin portion 88 engage the belt layers.

Also included within the crown 26 is a cushion layer 92 that is located on top of a reinforcement ply 32 in the crown 26 and provides a flat surface onto which the belt layers can be disposed. The majority of the cushion layer 92 can be made of a recycled section 94 that includes recycled rubber, and a smaller portion of the cushion layer 92 can be made of a virgin section 96 that is made of virgin rubber. The virgin section 96 is not in contact with the reinforcement ply 32, but is in contact with the belt layer 104 and a belt edge layer 90. The recycled section 94 is of a larger volume of material than is the virgin section 96 in the tire 10, and the recycled section 94 is made of one piece and extends completely across the entire width of the crown 26 in the axial direction 16 and extends into the sidewalls 36. The recycled section 94 is located at the center of the tire 10 in the axial direction 16, and the virgin section 96 is not located at the center of the tire 10 in the axial direction 16. Instead, the virgin section 96 is made of two pieces that are spaced from one another such at one is at the left side of the crown 26 and the other is at the right side of the crown 26. The recycled section 94 extends beyond the virgin section 96 so that the recycled section 94 extends outboard of the recycled section 94 on both the left and right side of the tire 10 in the axial direction 16. The cushion layer 92 is not in contact with the undertread layer 84.

The embodiment in FIGS. 2 and 3 include four belt layers 100, 104, 108 and 112, where the steel belts provide reinforcement in the crown 26 for improved wear and cornering power. The steel belts allow the tire 10 to maintain its shape. A belt edge layer 90 acts as a wedge between the belt layers and the undertread layer 84 to dampen stresses and is present for endurance performance of the tire 10. The first belt layer 100 is the farthest of the belt layers from the center of the tire 10 in the radial direction 14 and engages the undertread layer 84 and is free from engagement with the cushion layer 92. The first belt layer 100 extends across the center of the tire 10 to the other side in the axial direction. A first axial end 102 of the first belt layer 100 is the terminal end of the first belt layer 100 and is the portion farthest from the center of the tire 10 in the axial direction 16. The first axial end 102 engages the virgin portion 88 and is free from engagement with the recycled portion 86. The virgin portion 88 is closer to the first axial end 102 than is the recycled portion 86 and extends inboard and outboard of the first axial end 102 in the axial direction 16. As the first axial end 102. Placement of the virgin portion 88 at the first axial end 102 protects the ending of the first belt layer 100 from rubber products with recycled rubber to maintain expected cured tire endurance performance.

A second belt layer 104 likewise extends across the tire 10 in the axial direction 16 so that it is located at the center of the tire 10. A second axial end 106 is located at the end of the second belt layer 104 and is the portion of the second belt layer 104 most outboard in the axial direction 16. The second axial end 106 engages the belt edge layer 90 which is made of virgin rubber. The virgin section 96 is closer to the second axial end 106 than is the recycled section 94 to the second axial end 106. The virgin section 96 extends both inboard and outboard of the second axial end 106, and the second axial end 106 is free from engagement with the recycled section 94. With this arrangement, virgin rubber surrounds and engages the second axial end 106 to protect the end of the second belt layer 104. Both the recycled section 94 and the virgin section 96 engage the second belt layer 104.

A third belt layer 108 with a third axial end 110 is present and is located between the first and second belt layers 100 and 104 in the radial direction 14. The third belt layer 108 extends to the other side of the tire 10 so that it is located in the center of the tire 10 in the axial direction 16. The third belt layer 108 engages the first and second belt layers 100 and 104, the belt edge layer 90, and the virgin portion 88. The third axial end 110 engages the virgin portion 88 and is free from engagement with the recycled portion 86. The third axial end 110 is closer to the virgin portion 88 than the recycled portion 86 and is protected by the presence of virgin rubber in its proximity so that the edge of the third belt layer 108 is not exposed to engagement with any recycled rubber. The belt edge layer 90 extends between the second and third belt layers 104, 108 in the radial direction 14. Portion of the third belt layer 108 engage the recycled section 94, and the third belt layer 108 is completely free from engagement with the undertread layer 84.

A fourth belt layer 112 is also present in the tire 10 and has a fourth axial end 114 that is the farthest portion of the fourth belt layer 112 outboard in the axial direction 16. The fourth belt layer 112 does not extend to the center of the tire 10 and is made of two pieces within the tire 10 and is not a single piece as is the case with the other belt layers 100, 104, 108. The fourth axial end engages the recycled section 94 and is free from engagement with the virgin section 96. The fourth belt layer 112 engages the second belt layer 104 and is the belt layer closest to the central axis 12 of the tire 10 in the radial direction 14. The fourth belt layer 112 is free from engagement with the undertread layer 84, the first belt layer 100, and the third belt layer 108. The fourth belt layer 112 does not engage any virgin rubber, and the only two components of the tire 10 that do engage the fourth belt layer 112 are the recycled section 94 and the second belt layer 104. It is therefore the case that not all of the ends of the belt layers engage virgin rubber, but at least some of the ends engage virgin rubber and not recycled rubber in various embodiments of the tire 10.

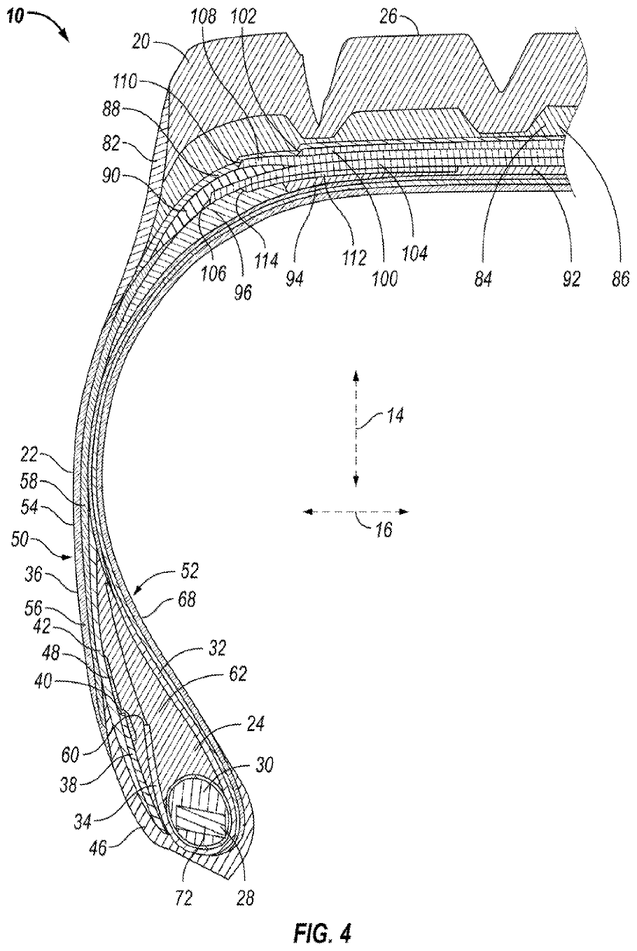

Another component of the tire 10 shown in FIGS. 3 and 4 is a tread wall 82 that is located at the axial end of the tread 20 and extends from it to a flank 54. The tread wall 82 is made of a different rubber composition than the tread 20 and engages both the tread 20, the undertread layer 84, the virgin layer 56 of the flank 54, and the recycled layer 58 of the flank 54. The tread wall 82 forms part of an exterior surface of the tire 10 and covers and engages the recycled portion 86.

A bead core 28 is located in each one of the beads 24 and is present to provide strength and a gripping force in the bead 24 for retention onto the rim. The left hand side bead 24 can be a mirror image of the right hand side bead 24 and both beads 24 can have products that are made of the same material. Some of the tissues/products are located only in the bead 24, while others are located in the bead 24 and extend therefrom. For instance, an inner liner 68 is inside of the bead 24 and extends to an inner, exterior side of the bead 24 before extending up the sidewall 36. The inner liner 68 then extends across the entire inner side of the crown 26 in the axial direction 16 before extending into and forming the inner side of the right hand side wall of the casing 22. The inner liner 68 then terminates inside of the right hand side bead 24 and is arranged in a similar mirror-image manner to its presence in the left hand side bead 24. The inner liner 68 is a product of the tire 10 that extends all the way from one bead 24 to the other bead 24 and is made of a material that is fluid tight so that fluid between the tire 10 and rim is maintained therein for purposes of maintaining inflation pressure of the tire 10. The inner liner 68 controls air retention, has low temperature cracking resistance, and has good flex fatigue resistance. The inner liner 68 can be made of a single layer or may be multi-layered. In the disclosed embodiment, the inner liner 68 is made of two layers. The inner liner 68 forms the inward exterior surface 52 of the sidewall 36.

The tire 10 includes a tissue designated as a reinforcement ply 32 that is located within one of the beads 28 and extends through the sidewall 36 and crown 26 to the other bead 28. The reinforcement ply 32 wraps around the bead core 28 and is designated as a return casing ply 34 in the location outward in the axial direction 16 from the bead core 28. The reinforcement ply 32 has a main portion that is in the bead 24 and is inboard from the return casing ply 34 in the axial direction 16. The main portion extends to the bead core 28 to a location of the reinforcement ply 32 that is closest to the central axis 12 in the radial direction 14. At this location closest to the central axis 12 in the radial direction 14, the reinforcement ply 32 is then designated as a return casing ply 34 which extends from this point to an outward radial terminal end 60 of the return casing ply 34 which is the part of the return casing ply 34 farthest from the central axis 12 in the radial direction 14. It is thus the case that both the main portion and the return casing ply 34 are wrapped around the bead core 28 and both may engage the bead core 28 in some embodiments. In the bead 24, the return casing play 34 may be completely located outboard of the main portion in the axial direction 16, although this arrangement need not always be the case. The main portion of the reinforcement ply 32 and its return casing ply 34 can be continuous with one another with no interruption in the reinforcement ply 32 from one to the other. The reinforcement ply 32 provides strength and flexibility to the tire 10, and it is the supporting structure for the inflation pressure which carries the load of the tire 10. The reinforcement ply 32 is a composite material that includes metal cords and a rubber mix. The reinforcement ply 32 in the direction of its cords is stiffer than the padding gum 30. The reinforcement ply 32 extends from the bead 24, through the sidewall 36, under the belt layers, and then into the opposite sidewall 36 and down into the bead 24 on the right hand side of the tire 10.

Relative positions in the axial direction 16 can be described with respect to inboard and outboard positions. The most inboard point of the tire 10 may be the radial direction line 14 shown in FIG. 2 in its location in FIG. 2 as it is located at the center of the tire 10 in the axial direction 16. The center of the tire 10 is inboard of both of the beads 24 in the axial direction 16. It is therefore the case as used herein, an object described as inboard in the axial direction 16 to another object means that it is located closer to the radial direction line 14 as shown in FIG. 2 or as would be located in the other figures. Further, as used herein an object described as being located outboard from another object in the axial direction 16 means that it is located farther from the radial direction line 14 in the axial direction 16 as shown in FIG. 2 or as would be located in the other figures. As another example, the stiffener layer 38 is outboard of the bead core 28 in the axial direction 16. Relative positioning in the radial direction 14 may be described in relation to the central axis 12 in which objects may be closer to or farther from the central axis 12 in the radial direction 14 than other objects. Although the central axis 12 is not shown in every figure due to sizing constraints, it is to be understood that when describing something as closer or farther in the radial direction 14, the position of the central axis 12 as would be seen should be referenced in order determine the relative positioning.

The bead core 28 is made up of one or more steel rods 72. The bead core 28 with the rod 72 function to hold the tire 10 onto the rim and to maintain the strength to withstand internal stresses from inflation on the rim to prevent slipping. The bead core 28 is surrounded by padding gum 30 and in some instances may be completely surrounded on all sides by the padding gum 30. Surrounding the bead core 28 is a wrapping tissue that can be made of nylon in some embodiments. The rod 72 making up the bead core 28 is shown as a single piece and has a rectangular cross-sectional shape. This single piece can actually be many rods arranged together in the shape of a rectangle. In other embodiments the bead core 28 can be made of multiple components and these components could have any cross-sectional shape. The wrapping tissue wraps around the padding gum 30 to isolate the rod 72 and padding gum 30 from other elements of the tire 10 such as the reinforcement ply 32 and fillers. The wrapping tissue may have a stiffness of 14 MPa and can be made of a rubber mix and textile which in some instances can be a nylon ply, the padding gum 30 can be a rubber mix and may have a stiffness of 28 MPa, and the rod 72 can be made of steel or aluminum and can have a stiffness of 30,000,000 MPa in some embodiments. The bead core 28 can be lightened so that a smaller rod can be used to improve performance properties of the tire 10.

The bead filler 62 is located between and engages both the stiffener layer 38 and the return casing ply 34. The bead filler 62 also engages the return casing ply 34, tape 48, and the bead layer. The bead filler 62 is made of a first layer and a second layer which may be made of the same material. The reason the bead filler 62 is made of two layers is because this may be easier in the manufacturing process. The first and second layers may include only virgin rubber with no recycled rubber. In other embodiments, portions of the first and second layers may include both virgin and recycled rubber.

Tape 48 surrounds the outward radial terminal end 40 of the stiffener layer 38 so that it does not engage the bead filler 62. The tape 48 may be present on the outward radial terminal end 40 when the stiffener layer 38 is assembled into the green tire 10 before curing. The tape 48 could be wrapped around the outward radial terminal end 40 in this regard before and after assembly of the stiffener layer 38 into the tire 10. Although the tape 48 is shown as being present, it is to be understood that the tape 48 is not present in the tire 10 in other exemplary embodiments of the tire 10. The provided configuration of the bead 24 allows the elimination of tape 48 at the ends of all products thus decreasing cost of the tire 10 and reducing complexity of the tire 10.

The stiffener layer 38 can be made of a combination of steel and rubber, and this rubber may have a stiffness of 10 MPa. The bead 24 includes an anti-abrasive strip 46 that is on the outside of the bead 24 and is designed to engage the rim. The anti-abrasive strip 46 engages the stiffener layer 38, but need not in other arrangements. The stiffener layer 38 in FIG. 3 extends outward in the radial direction 14 to have a portion outward of the bead core 28, and the return casing ply 34 in the radial direction 14.

The bead layer 42 is a product of the tire 10 made of rubber that has a portion that engages the stiffener layer 38 and is located between the stiffener layer 38 and the anti-abrasive strip 46. The bead layer 42 extends outward in the radial direction 14 to an outward radial terminal end that is the farthest outward position of the bead layer 42 from the central axis 12 in the radial direction 14 and engages the tape 48, the bead filler 62, and the flank 54. The bead layer 42 may extend to the sidewall 36 of the tire 10, and in some instances may be located within the sidewall 36. The bead layer 42 does not form any part of the exterior surface of the tire 10, and does not extend to the crown 26 to be under the belt layers, and does not extend to the right hand side sidewall or right hand side bead.

The present application describes the stiffness of a product or material. The stiffness that is being referred to is the Young's modulus which is the stiffness of an elastic material, or elastic modulus. The stiffness is provided in measurements of mega pascals (MPa). The stiffness material property in question that is being referred to is MA10. This stiffness property can be calculated using French standard NF T 46-002, September 1988.

The sidewall 36 includes a flank 54 that is made of a virgin layer 56 and a recycled layer 58. The virgin layer 56 and recycled layer 58 are include rubber such that the virgin layer 56 has no recycled rubber in it, and such that the recycled layer 58 lacks any virgin rubber and has in it only recycled rubber. The virgin layer 56 forms at least a portion of the outward exterior surface 50 of the sidewall 36. The flank 54 may be located only in the sidewall 36, or may be in both the sidewall 36 and the bead 24, or may be in both the sidewall 36 and the crown 26. In some embodiments, the flank 54 may be in the crown 26, sidewall 36, and also the bead 24. The flank 54 does not extend across the crown 26 to the other sidewall. The recycled layer 58 forms no part of the outward exterior surface 50 and is a portion of the flank 54 completely contained within the interior of the tire 10 forming no part of any exterior surface of the tire 10. Other embodiments of the tire 10 exist in which the flank 54 does not include any recycled rubber. In these instances, the recycled layer 58 is made instead of virgin rubber such that the flank 54 includes both layers 56 and 58 and are made completely of virgin rubber with no recycled rubber being present. As such, it is to be understood that embodiments exist with no recycled rubber in the sidewall 36 such that the recycled bead filler 64 is physically present but part of the virgin bead filler 62 and of the same material as the virgin bead filler 62 which is all virgin rubber with no recycled rubber.

The virgin layer 56 engages the anti-abrasive strip 46, the recycled layer 58, and the tread wall 82, and is free from engagement with all other described portions of the tire 10. The recycled layer 58 engages the virgin layer 56, the anti-abrasive strip 46, the bead layer 42, the reinforcement ply 32, the cushion layer 92 (in some instances the recycled section 94 of the cushion layer 92), the belt edge layer 90, the undertread layer 84 (in some instances the recycled portion 86 of the undertread layer 84), and the tread wall 82, and is free from engagement with all other described portions of the tire 10. Various parts of the tire 10 have been descried as being made of recycled rubber, but is to be understood that in some embodiments the only recycled rubber present in the tire 10 is in the recycled section 94 and the recycled section 86. In these instances, all other parts of the tire 10 that have rubber have such rubber being virgin rubber. In some embodiments, recycled rubber is present in the crown 26, but not in the bead 24 and the sidewall 36. In other embodiments, recycled rubber is present in only the crown 26 and the sidewall 36, but not in the bead 24. Yet further, in other embodiments recycled rubber is present in the crown 26 and the bead 24, but not in the sidewall 36. In yet other embodiments the crown 26, sidewall 36, and bead 24 all include some recycled rubber.

In the various embodiments of the tire 10, the volume of material making up the total of the virgin portion 88 and the virgin section 96 is the same as, greater than, or less than the volume of material making up the total of the recycled portion 86 and the recycled section 94. In this regard, the volume can be determined as a size comparison of the area of the virgin portion 88 plus virgin section 96 of the crown 26 to the size area of the recycled portion 86 plus the recycled section 94 of the crown 26 when taking a cross-section of the crown 26 such as the ones shown in FIGS. 2-5. The undertread layer 84 and the cushion layer 92 may form no part of any exterior surface of the tire 10 and may all be completely contained within the tire 10 and not visible from the outside. There may be more recycled rubber in the crown 26 than in the sidewall 36 and the beads 24 combined. In other embodiments, the crown 26 can have less recycled rubber in it than the amount of recycled rubber in the sidewall 36 and beads 24 combined.

FIG. 4 shows an alternate exemplary embodiment of the tire 10 that likewise includes the crown 26 having the virgin portion 88 and virgin section 96 along with the recycled portion 86 and the recycled section 94. The differences between the FIG. 4 embodiment and the FIGS. 2/3 embodiment lie in the configuration of the undertread layer 84 and cushion layer 92. Aside from these difference that will be momentarily discussed, the rest of the configuration of the tire 10 is the same as the FIGS. 2/3 embodiment described above and a repeat of this information is not necessary. In the FIG. 4 embodiment, the undertread layer 84 includes a recycled portion 86 that engages the tread 20 and the tread walls 82 and is free from engagement with the belt edge layer 90 and the first belt layer 100. The virgin portion 88 is made of a single piece and extends along the entire crown 26 in the axial direction 16. The virgin portion 88 engages the recycled portion 86, first and third belt layers 100 and 108, the belt edge layer 90, the tread wall 82, and the recycled layer 58. As with the FIGS. 2/3 embodiment, the virgin portion 88 does not engage the virgin section 96. Both the first axial end 102 and the third axial end 110 engage the virgin portion 88, and the virgin portion 88 extends along the majority of the length of the belt edge layer 90 in the axial direction 16 to be outboard of the belt edge layer 90 in the axial direction 16. The first axial ends 102 and third axial end 110 are again closer to virgin rubber than to recycled rubber, and engage and are surrounded by only virgin rubber.

The cushion layer 92 is configured differently in the FIG. 4 embodiment from that of the FIGS. 2/3 embodiment. The recycled section 94 is again made of a single piece and is located at the center in the axial direction 16, and the virgin section 96 is again made of two pieces but extends a longer distance in the axial direction 16. The virgin section 96 engages the fourth belt layer 112, the reinforcement ply 32, the recycled section 94, the recycled layer 58, the belt edge layer 90, and the second belt layer 104. In this embodiment the virgin section 96 engages the fourth axial end 114, and the fourth axial end 114 is closer to and surrounded by virgin rubber as opposed to being closer to and surrounded by recycled rubber. The second axial end 106 again engages virgin rubber and is surrounded by and closer to virgin rubber than to recycled rubber. The virgin section 96 and the virgin portion 88 are not in engagement with one another and are separated at one point by just the recycled layer 58, and at another point by just the belt edge layer 90. The design in the FIG. 4 embodiment features virgin rubber in the crown 26 that protects the axial ends 102, 106, 110, 114 such that recycled rubber is not in contact with these elements and is spaced from these elements such that virgin rubber is in closer proximity to these elements than recycled rubber. In the rest of the tire, the sidewall 36 has a virgin layer 56 with virgin rubber, and a recycled layer 58 that is made of recycled rubber. The bead 24 has only virgin rubber and no recycled rubber. In this regard, the bead 24 has two layers of virgin bead filler 62 made of virgin rubber, but no recycled rubber.

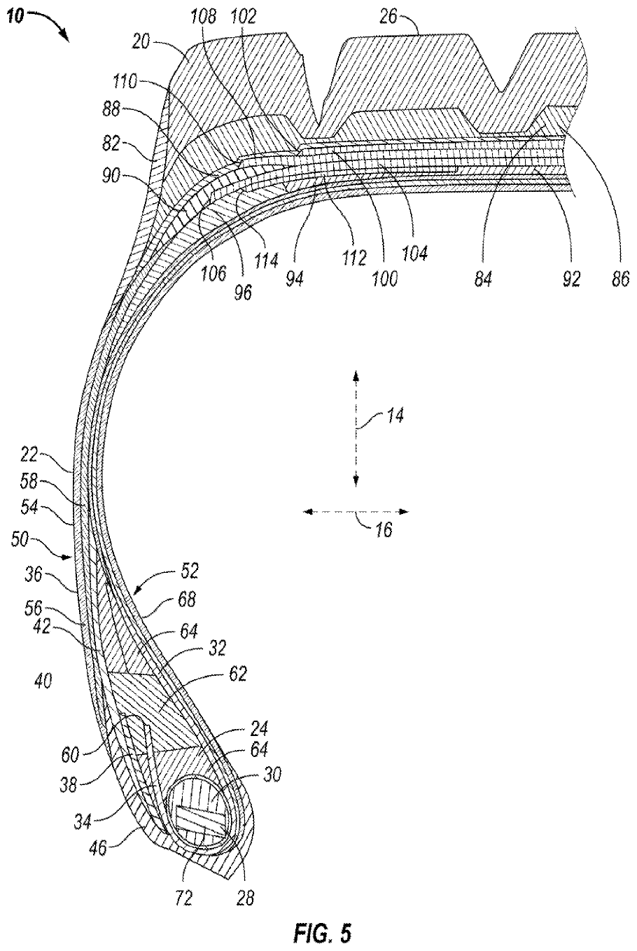

Another embodiment of the tire 10 is shown in FIG. 5. The crown 26 with the virgin portion 88, virgin section 96, recycled portion 86, and recycled section 94 are arranged is a similar manner as previously discussed with respect to the FIG. 4 embodiment and need not be repeated. The sidewall 36 is again configured with a virgin layer 56 made of virgin rubber, and a recycled layer 58 made of recycled rubber. However, the bead 24 is configured so as to have both virgin rubber and recycled rubber so that the crown 26, sidewall 36 and beads 24 all include recycled rubber in addition to virgin rubber. The bead 24 has two layers of recycled bead filler 64 that include only recycled rubber and no virgin rubber. These two layers are broken up into two parts in which two of the layers are close to the bead core 28. One of the layers of the recycled bead filler 64 engage nylon wrapping, and the other layer of the recycled bead filler 64 is located between the stiffener layer 38 and the return casing ply 34. Adjacent and contacting these two recycled bead filler 64 layers is the virgin bead filler 62 which is likewise broken up into two layers. The outward radial terminal end 40 and the outward radial terminal end 60 both engage the virgin bead filler 62 and do not engage the recycled bead filler 64. The outward radial terminal ends 40, 60 are closer to and surrounded by virgin rubber and not recycled rubber. Located radially outward from the virgin bead filler 62 is the other part of the recycled bead filler 64 which is again composed of two layers. This radially outward part of the recycled bead filler 64 engages the bead layer 42, the virgin bead filler 62, and the reinforcement ply 32 and is free from contact with all of the other portions of the tire 10. In the tire 10, recycled rubber is present in the crown 26, beads 24, and sidewalls 36 but are strategically located therein so that they are not at certain locations in these parts 26, 24, 36 but instead virgin rubber is located at these certain locations.

The arrangements disclosed herein with the strategic placement of the virgin rubber and recycled rubber protects the is arrangement protects the endings of belt layers in the crown 26 from rubber products with recycled rubber. This protection allows the crown 26 to maintain the expected cured tire 10 endurance performance. As disclosed in the various embodiments herein, the tire 10 is made of multiple layers, and these products can be layered into the tire 10 using a coextrusion process. Other combinations of layering could be created by mixing and matching the disclosed arrangements.

The various embodiments disclosed herein can incorporate any type of recycled rubber into the recycled portion 86 and recycled section 94 (or other parts that include recycled rubber as disclosed herein) such that the recycled portion 86 and recycled section 94 can incorporate any type of recycled rubber. The recycled rubber can be included only in the crown 26, and need not be in other portions of the tire 10 such as the sidewall 36 or the beads 24. The volume of the crown 26 can be from 1% to 10%, from 10%-30%, from 12%-15%, from 5%-15%, from 15%-25%, from 20%-30%, from 25%-35%, 12%, 15%, 20%, 10%, or from 12%-20%, or up to 15% of recycled rubber. In yet other embodiments, the volume of the crown 26 could be from 15%-20%, from 15%-25%, from 20%-30%, from 25%-35%, from 30%-40%, from 40%-50%, or from 45%-50% recycled rubber. As such, recycled rubber could make up various amounts of the volume of the crown 26 in other arrangements. The volume can be determined by taking a cross-section of the crown 26 and measuring the area of the recycled rubber in comparison to the total area of the cross-section of the crown 26. If there is some confusion as to what constitutes the crown 26 versus what constitutes the sidewalls 36 as these parts are contiguous, the sidewall 36 could thus be defined as the portion of the tire 10 that forms the sidewall 36 as measured from the radially outward end of the bead filler 62 to the radially inward end of the undertread layer 84. This length in the radial direction 14 will be the height of the sidewall 36, and the full width in the axial direction 16 of one of the sidewalls 36 of the tire 10 will be its width. This area can be measured to ascertain the volume of recycled rubber within.

In some embodiments, new tires 10 for light duty vehicles can include 12% recycled rubber in the crown 26, and new tires 10 for commercial vehicles can include 15% recycled rubber in the crown 26. The incorporation of recycled rubber in the geometry introduced herein in the crown 26 may be done so without degrading tire 10 performance or increasing manufacturing cost. Existing crown 26 endurance and durability performance may be maintained with the incorporation of recycled rubber through the use of the multi-layer strategy by making the undertread layer 84 out of two portions 86, 88 and the cushion layer 92 out of the two sections 94, 96. The multi-layer arrangements and placement of the recycled rubber allows the crown 26 of the tire 10 to maintain product performance even though recycled materials are included therein.

The recycled portion 86 and the recycled section 94, and any other part of the tire 10 described herein as having recycled rubber, can be any type of recycled rubber, which is rubber product that has been cured and previously used in a product such as a tire or rubber hose. The rubber in the recycled portion 86 and the recycled section 94 is always vulcanized rubber, and may be reprocessed vulcanized rubber from a tire that is put into the current tire 10. In some embodiments, the recycled rubber is micronized rubber powder (MRP) that is obtained from used tires. In some embodiments, the micronized rubber powder is a micronized rubber composition having a particle size which is within a range of 40 mesh to 200 mesh, wherein the micronized rubber composition is comprised of at least 10 weight percent solution styrene-butadiene rubber. In some arrangements the crown 26 is from 10%-30% MRP by volume. The micronized rubber powder may be as that provided in U.S. Pat. No. 9,815,974 entitled “recycled micronized rubber formulation having improved abrasion resistance”, the contents of which are incorporated by reference herein for all purposes.

While the present subject matter has been described in detail with respect to specific embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be apparent.

1. A tire that has a central axis, a radial direction, and an axial direction, comprising:
a crown that has tread that is configured for engaging a road;
a sidewall that extends from the crown; and
a bead that extends from the sidewall;
wherein the crown has an undertread layer that has a recycled portion that includes recycled rubber, and wherein the undertread layer has a virgin portion that includes virgin rubber;
wherein the crown has a cushion layer that has a recycled section that includes recycled rubber, and wherein the cushion layer has a virgin section that includes virgin rubber;
a plurality of belt layers that are located between the undertread layer and the cushion layer in the radial direction, wherein the virgin portion engages a first one of the plurality of belt layers and is located proximate to a first axial end of the first one of the plurality of belt layers, wherein the virgin section engages a second one of the plurality of belt layers and is located proximate to a second axial end of the second one of the plurality of belt layers.

2. The tire as set forth in claim 1, wherein the virgin portion engages the first axial end of the first belt layer, and wherein the recycled portion engages the first belt layer and is free from engagement with the first axial end of the first belt layer;
wherein the virgin section and the recycled section both engage the second belt layer and are both free from engagement with the second axial end of the second belt layer.

3. The tire as set forth in claim 1, wherein the crown has a belt edge layer that includes virgin rubber, wherein the belt edge layer engages the second axial end of the second belt layer;
wherein the belt edge layer engages the virgin portion and the recycled portion, and wherein the belt edge layer engages the virgin section and the recycled section.

4. The tire as set forth in claim 1, wherein a third belt layer of the plurality of belt layers is located between the first and second belt layers in the radial direction, wherein the third belt layer has a third axial end that engages the virgin portion and is free from engagement with the recycled portion and the cushion layer;
wherein a fourth belt layer of the plurality of belt layers is located inward in the radial direction from the first, second, and third belt layers, wherein the fourth belt layer has a fourth axial end that engages the recycled section and is free from engagement with the virgin section and the undertread layer.

5. The tire as set forth in claim 1, wherein the first axial end of the first belt layer engages the virgin portion, and wherein the first belt layer is free from engagement with the recycled portion;
wherein the second axial end of the second belt layer is free from engagement with the recycled section and the virgin section, and wherein the second belt layer engages both the recycled section and the virgin section.

6. The tire as set forth in claim 1, wherein the crown has a belt edge layer that includes virgin rubber, wherein the belt edge layer engages the virgin portion and is free from engagement with the recycled portion;
wherein the belt edge layer engages the virgin section and is free from engagement with the recycled portion, and wherein the belt edge layer engages the second axial end of the second belt layer.

7. The tire as set forth in claim 1, wherein a third belt layer of the plurality of belt layers is located between the first and second belt layers in the radial direction, wherein the third belt layer has a third axial end that engages the virgin portion and is free from engagement with the recycled portion and the cushion layer;
wherein a fourth belt layer of the plurality of belt layers is located inward in the radial direction from the first, second, and third belt layers, wherein the fourth belt layer has a fourth axial end that engages the virgin section and is free from engagement with the recycled section and the undertread layer, wherein the fourth belt layer engages the recycled section.

8. The tire as set forth in claim 1, wherein the sidewall has an outward exterior surface and an inward exterior surface, wherein the sidewall has a flank that forms at least part of the outward exterior surface, wherein the flank has a virgin layer and a recycled layer, wherein the virgin layer forms at least part of the outward exterior surface and wherein the recycled layer forms no part of the outward exterior surface, wherein the virgin layer includes virgin rubber, and wherein the recycled layer includes recycled rubber.

9. The tire as set forth in claim 8, wherein the sidewall has a reinforcement ply that engages the recycled layer, wherein the reinforcement ply extends into the bead and extends into the crown, wherein the reinforcement ply wraps around a portion of a bead core of the bead;
wherein the sidewall has an inner liner that forms the inward exterior surface, wherein the inner liner extends into the bead and extends into the crown.

10. The tire as set forth in claim 9, wherein the inner liner engages the reinforcement ply, and wherein the reinforcement ply and flank form no part of the inward exterior surface, wherein the reinforcement ply and the inner liner include virgin rubber and do not include any recycled rubber.

11. The tire as set forth in claim 8, wherein the recycled layer engages the recycled portion and the recycled section and is free from engagement with the virgin portion and the virgin section;
wherein the virgin layer is free from engagement with the undertread layer and the cushion layer.

12. The tire as set forth in claim 8, wherein the recycled layer engages the virgin section, the virgin portion and a belt edge layer of the crown, and wherein the recycled layer is free from engagement with the recycled portion and the recycled section;
wherein the virgin layer is free from engagement with the undertread layer and the cushion layer.

13. The tire as set forth in claim 1, wherein the bead has a bead core that has a rod and padding gum, wherein a reinforcement ply wraps around a section of the bead core and has a main portion and a return casing ply that extends from the main portion and is outboard in the axial direction from the bead core, wherein the return casing ply has an outward radial terminal end;
wherein the bead has virgin bead filler that has a portion radially outward from the bead core in the radial direction and axially outboard from the reinforcement ply in the axial direction, wherein the virgin bead filler includes virgin rubber;
wherein the bead has recycled bead filler that has a portion located radially outward from the bead core in the radial direction and axially outboard from the reinforcement ply in the axial direction, wherein the recycled bead filler includes recycled rubber;
wherein the bead has a stiffener layer that has a portion located outboard from the return casing ply in the axial direction, wherein the stiffener layer has an outward radial terminal end;
wherein the outward radial terminal end of the return casing ply is closer to the virgin bead filler than to the recycled bead filler, and wherein the outward radial terminal end of the return casing ply is not in engagement with the recycled bead filler;
wherein the outward radial terminal end of the stiffener layer is closer to the virgin bead filler than to the recycled bead filler, and wherein the outward radial terminal end of the stiffener layer is not in engagement with the recycled bead filler.

14. The tire as set forth in claim 1, wherein from 10%-30% of the volume of the crown is made of micronized rubber powder that is present in the recycled portion and the recycled section.

15. The tire as set forth in claim 14, wherein from 12%-15% of the volume of the crown is made of micronized rubber powder that is present in the recycled portion and the recycled section.

16. The tire as set forth in claim 1, wherein the recycled portion and the recycled section include a micronized rubber composition having a particle size which is within a range of 40 mesh to 200 mesh, wherein the micronized rubber composition is comprised of at least 10 weight percent solution styrene-butadiene rubber.
